(19) United States
(12) Patent Application Publication
(10) Pub. No.: US 2008/0116801 A1
(43) Pub. Date: May 22, 2008

(54) PLASMA DISPLAY

(75) Inventors: Chong-Gi Hong, Yongin-si (KR); Tae-Kyoung Kang, Yongin-si (KR)

Correspondence Address: CHRISTIE, PARKER & HALE, LLP, PO BOX 7068, PASADENA, CA, 91109-7068, US

(73) Assignee: Samsung SDI Co., Ltd., Suwon-si (KR)

(21) Appl. No.: 11/844,327

(22) Filed: Aug. 23, 2007

(30) Foreign Application Priority Data
Nov. 17, 2006 (KR) 1020060114083

(51) Int. Cl. H01J 17/49

(52) U.S. Cl. 313/583; 313/582; 313/584

(57) ABSTRACT

A plasma display panel is provided having a first substrate, a second substrate facing the first substrate, and barrier ribs arranged on the second substrate to form discharge cells between the first substrate and the second substrate. The plasma display panel further includes first electrodes and second electrodes on the first substrate facing each other in the discharge cells. A first connection bar connects end portions of the first electrodes. A second connection bar is electrically connected to the first connection bar and is spaced apart from the first connection bar. Terminals extend from the second connection bar.

### CROSS-REFERENCE TO RELATED APPLICATION

This application claims priority to and the benefit of Korean Patent Application No. 10-2006-0114083 filed in the Korean Intellectual Property Office on Nov. 17, 2006, the entire content of which is incorporated herein by reference.

### BACKGROUND OF THE INVENTION

1. Field of the Invention

The present invention relates to a plasma display panel having an improved image display capability.

2. Description of the Related Art

A plasma display panel (PDP) is a display device in which an image is formed by using visible light generated when ultraviolet rays, which are emitted from plasma produced by a gas discharge, excite a phosphor layer. Due to their large screen size with high resolution, PDPs are highly anticipated as the next generation flat panel display devices.

In general, the PDP has a three-electrode surface discharge type structure in which a pair of electrodes are formed on a front substrate and address electrodes are provided on a rear substrate spaced apart from the front substrate. The electrodes respectively correspond to discharge cells.

Millions of unit discharge cells may be arranged inside the PDP in a matrix form. By using a memory characteristic of wall charges, particular discharge cells are selected for turning on to display an image.

In order to control the PDP, each electrode has terminals formed at end portions of the substrates. The terminals are connected to a driving board so as to supply driving voltages required for the electrodes.

Because the PDP is driven at a high voltage, heat generation in the terminals where the electrodes are present has been a problem. The problem is severe at a terminal of a sustain electrode constituting a common electrode and is even more severe in an aging process for stabilizing a state of a discharge cell after the PDP is manufactured. In the aging process, the PDP is continuously driven for a long period of time at a voltage higher than the driving voltage.

When the terminals or the substrate are exposed to high heat for a long period of time, damage may occur in a terminal or in the substrate itself.

### SUMMARY OF THE INVENTION

Exemplary embodiments of the present invention protect a terminal against heat. According to an aspect of the present invention, a plasma display panel is provided having a first substrate, a second substrate facing the first substrate, and barrier ribs arranged on the second substrate to form discharge cells between the first substrate and the second substrate. The plasma display panel further includes first electrodes and second electrodes on the first substrate facing each other in the discharge cells. A first connection bar connects end portions of the first electrodes. A second connection bar is electrically connected to the first connection bar and is spaced apart from the first connection bar. Terminals extend from the second connection bar.

In the aforementioned aspect of the present invention, the first connection bar may be formed extending parallel with the address electrodes. Further, the second connection bar may be spaced apart from the first connection bar at a predetermined distance.

According to an exemplary embodiment of the present invention, edges of the first substrate and the second substrate may be sealed with a sealant, and the first connection bar may be located at an area sealed within the sealant.

According to an exemplary embodiment of the present invention, the second connection bar may be adjacent to the sealant in an inner side of the area sealed within the sealant, or alternatively may be adjacent to the sealant in an outer side of the area sealed within the sealant.

According to an exemplary embodiment of the present invention, holes may be selectively formed through the second connection bar.

### BRIEF DESCRIPTION OF THE DRAWINGS

FIG. 1 is a schematic plan view of a plasma display panel constructed according to an exemplary embodiment of the present invention.

FIG. 2 is an exploded perspective view showing a structure of a portion A of FIG. 1.

FIG. 3 is a partial enlarged plan view of a terminal of a sustain electrode.

FIG. 4 is a plan view showing an example of forming a second connection bar externally formed adjacent to a sealant.

FIG. 5 shows holes formed through the second connection bar.

### DETAILED DESCRIPTION

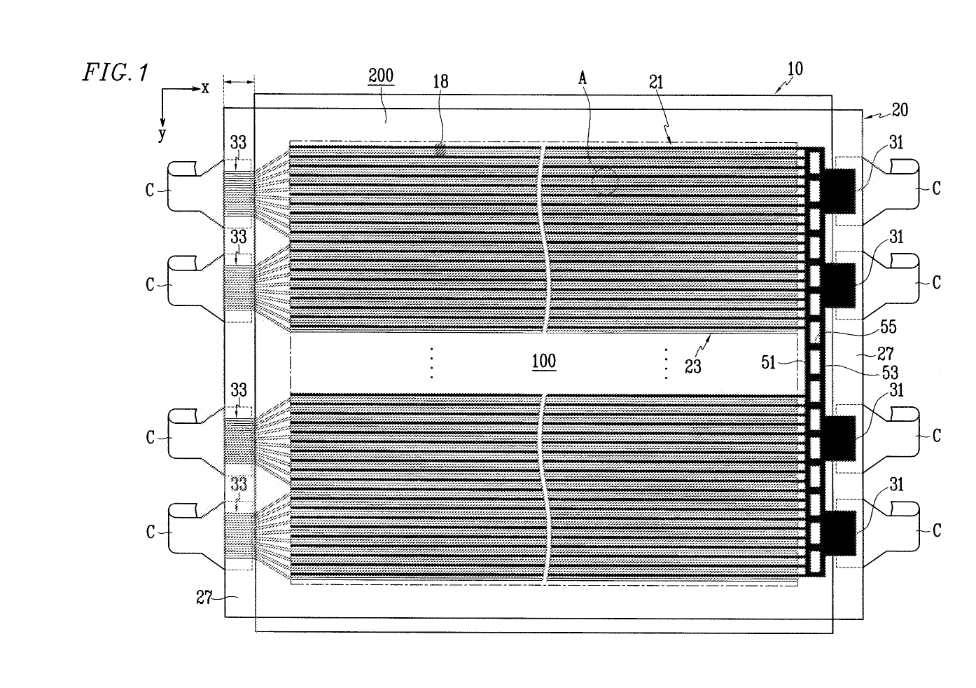

FIG. 1 is a schematic plan view of a plasma display panel (hereinafter, referred to as a PDP) constructed according to an exemplary embodiment of the present invention.

Referring to FIG. 1, the PDP according to the present exemplary embodiment includes a front substrate 20 and a rear substrate 10 that are sealed with each other while facing each other, for example, with a predetermined gap. The space between the substrates 20, 10 is provided with a plurality of discharge cells 18 defined by barrier ribs so as to generate a plasma discharge.

The discharge cells 18 constitute a display area 100. The PDP is divided into the display area 100 and a non-display area 200. The display area 100 is an area where the plasma discharge occurs among the discharge cells 18, thereby actually displaying an image. The non-display area 200 is an area that forms a margin for the process of manufacturing.

Along the discharge cells 18, first electrodes 23 (hereinafter, referred to scan electrodes) and second electrodes 21 (hereinafter, referred to as sustain electrodes) are formed in one direction (x-axis direction in the drawing) on a surface where the front substrate 20 faces the rear substrate 10.

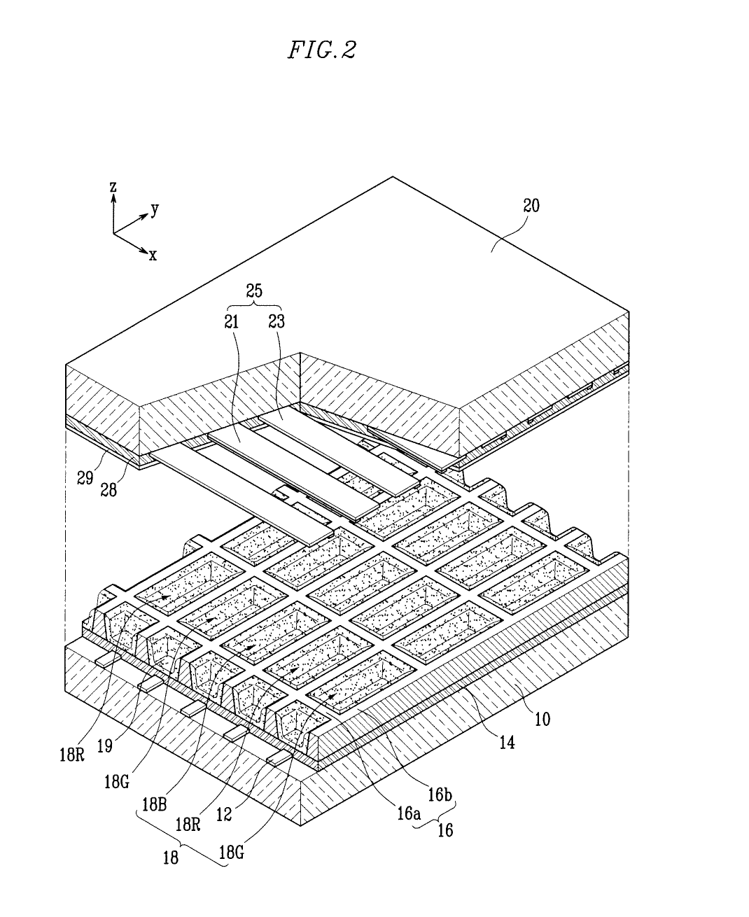

FIG. 2 is an exploded perspective view showing a structure of a portion A of the plasma display panel illustrated in FIG. 1. The sustain electrodes 21 and the scan electrodes 23 form display electrodes 25. Address electrodes 12 are formed on a surface where the rear substrate 10 faces the front substrate 20, wherein the address electrodes 12 cross the display electrodes 25 and the discharges cells 18.

The scan electrodes 23 of the display electrodes 25 select the discharge cells 18 that are turned on according to an interaction with the address electrodes 12. The sustain electrodes 21 generate a sustain-discharge in the discharge cells 18 selected as described above. Thus, a driving voltage for selecting the discharge cells 18 is selectively supplied to the scan electrodes 23 by distinguishing the scan electrodes 23. However, the driving voltage is supplied to all of the sustain electrodes 21 without having to distinguish the sustain electrodes 21.

Referring to FIG. 1, the scan electrodes 23 and the sustain electrodes 21 respectively extend in one direction (x-axis direction in the drawing). Thus, terminals 31, 33 are respectively formed at each end of the front substrate 20. The terminals 31, 33 are connected to a circuit board (not shown) that allows the display electrodes 25 to generate electrical driving signals. In the drawing, the scan electrodes 23 extend from the terminals 33 in a positive x-axis direction, whereas the sustain electrodes 21 extend from the terminals 31 in a negative x-axis direction.

The rear substrate 10 is sealed with the front substrate 20 in a crossed manner. Exposure areas 27 are formed at both ends of the front substrate 20. The exposure areas 27 belong to the non-display area 200 of the PDP. The scan electrodes 23 and the sustain electrodes 21 formed along the discharge cells 18 of the display area 100 respectively form the terminals 31, 33 in the exposure areas 27.

The edges of the rear substrate 10 and the front substrate 20 are sealed with a sealant, thereby isolating the inner side of the PDP from outside.

As shown in the drawing, the terminals 31, 33 of the scan electrodes 23 and the sustain electrodes 21, respectively, form electrode groups including a plurality of scan electrodes 23 and a plurality of sustain electrodes 21. End portions of the electrode groups are disposed in one of the exposure areas 27, thereby forming the terminals 31, 33.

End portions of the sustain electrodes 21 are electrically connected through a first connection bar 51. A second connection bar 53 is formed spaced apart from the first connection bar 51 by a particular distance (e.g., a predetermined distance). The first connection bar 51 is connected to the second connection bar 53 through connection wires 55. The terminals 31 extend from the second connection bar 53 so as to be formed in one of the exposure areas 27.

In the present exemplary embodiment, as described above, the first connection bar 51 and the second connection bar 53 are formed at the end portions of the sustain electrodes 21, thereby protecting the terminals 31 against heat concentration.

The terminals 31, 33 formed as described above are connected to the driving board while being electrically in contact with a flexible signal line C (e.g., FPC, TCP). Accordingly, a driving voltage for controlling a charge state for each discharge cell 18 is supplied to the display electrodes 25, thereby generating a discharge.

The structure of the discharge cells in the display area will be described in detail with reference to FIG. 2. In the PDP of the present exemplary embodiment, a front substrate 20 and a rear substrate 10 face each other. Further, a space between the substrates 20, 10 is provided with discharge cells 18 defined by barrier ribs 16. The discharge cells 18 constitute a sub-pixel that is a minimum unit for displaying an image. A plurality of sub-pixels constitute one pixel.

Display electrodes 25 and address electrodes 12 are formed in correspondence with respective discharge cells 18. The display electrodes 25 and the address electrodes 12 are spaced apart from each other, and extend in directions such that the two electrodes 25, 12 cross each other. The discharge cells 18 are respectively located at points where the display electrodes 25 cross the address electrodes 12.

The display electrodes 25 are formed on the front substrate 20. The scan electrodes 23 and the sustain electrodes 21 face the discharge cells 18, thereby forming a discharge gap.

The display electrodes 25 are buried with and protected by a dielectric layer 28 formed of a dielectric material (e.g., PbO, B₂O₃, and SiO₂). The dielectric layer 28 protects the display electrodes 25 against damage caused by collision of charge particles during a discharge. The dielectric layer 28 may be covered with a passivation layer 29 (e.g., MgO).

The address electrodes 12 may be formed on the rear substrate 10 facing the front substrate 20. As illustrated in the drawing, the address electrodes 12 cross the display electrodes 25, and extend in one direction (y-axis direction in the drawing) in correspondence with the discharge cells 18. Further, the address electrodes 12 are formed parallel to neighboring address electrodes 12.

The address electrodes 12 are protected while being buried with a dielectric layer 14. The barrier ribs 16 are formed above the address electrodes 12 so as to define the discharge cells 18, wherein each barrier rib 16 includes a first barrier member 16a extending in the x-axis direction in the drawing and a second barrier member 16b extending in the y-axis direction in the drawing.

Phosphor layers 19 emitting visible light of respective colors are formed inside the discharge cells 18. In order to display an image, the phosphor layers 19 are formed in the discharge cells 18 for red R, green G, and blue B colors. A red discharge cell 18R, a green discharge cell 18G, and a blue discharge cell 18B as one group constitute one pixel.

The insides of the discharge cells 18 formed with the phosphor layers 19 are filled with a mixture gas, such as neon and xenon.

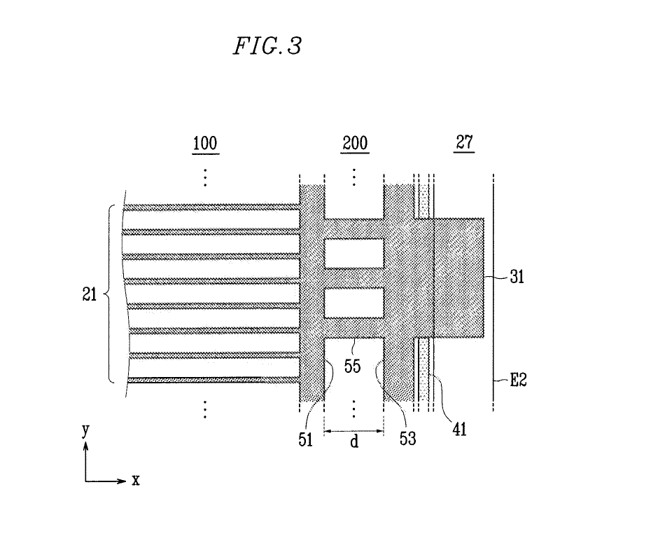

The structure of the terminals 31 of the sustain electrodes 21 will now be described with reference to FIG. 3. FIG. 3 is a partial enlarged plan view of a terminal of a sustain electrode.

The sustain electrodes 21 extend from the display area 100 to the non-display area 200. Further, the sustain electrodes 21 are connected to the first connection bar 51 in the non-display area 200. The sustain electrodes 21 extend in the x-axis direction in the drawing. The first connection bar 51 is formed extending in the y-axis direction in the drawing, crossing the sustain electrodes 21.

The first connection bar 51 is located at the inner side of an area that is sealed with a sealant 41.

The second connection bar 53 is formed parallel to the first connection bar 51, and is spaced apart from the first connection bar 51 by a distance d, which may be a predetermined distance. Further, the second connection bar 53 is formed extending in the y-axis direction, like the first connection bar 51. Accordingly, a space is formed between the first connection bar 51 and the second connection bar 53.

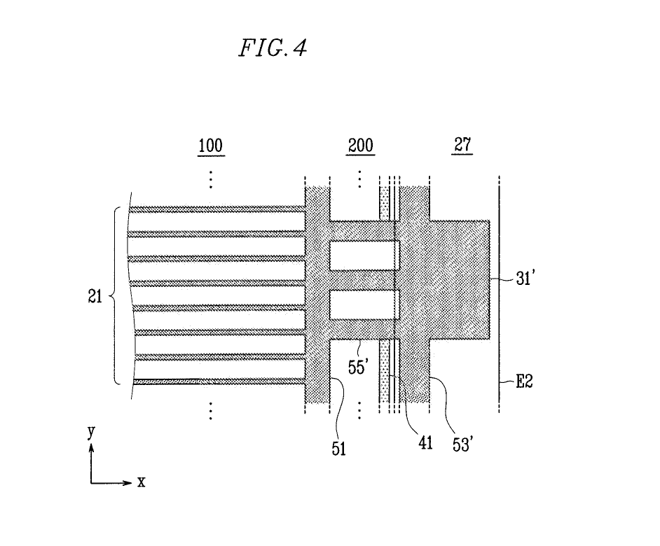

The second connection bar 53 may be formed in an inner side 200 of the area sealed with the sealant 41. Alternatively, as shown in FIG. 4, the second connection bar 53′ may be formed in an outer side 27 of the area sealed with the sealant 41.

When the second connection bar 53′ is formed in the outer side 27 of the area sealed with the sealant 41, the second connection bar 53′ is exposed to the air. Therefore, even if a high voltage is supplied to the terminals 31′, because the second connection bar 53′ is in contact with the air, heat is diffused to the air, thereby rapidly dissipating the heat of the terminals 31′.

In this manner, the terminals 31, 31′ are formed along the second connection bar 53, 53′, respectively, that is spaced apart from the first connection bar 51 and is parallel thereto.

The terminals 31, 31′ extend from the second connection bar 53, 53′, respectively, in the x-axis direction to the exposure area 27. The terminals 31 extend from the second connection bar 53 across the sealant 41. The terminals 31′ extend from the second connection bar 53′ without crossing the sealant 41.

As depicted in FIG. 3, a plurality of connection wires 55 are formed between the first connection bar 51 and the second connection bar 53 so as to electrically connect the first connection bar 51 and the second connection bar 53. As depicted in FIG. 4, a plurality of connection wires 55′ are formed between the first connection bar 51 and the second connection bar 53′ so as to electrically connect the first connection bar 51 and the second connection bar 53′.

Because the first connection bar 51 is connected to the second connection bar 53, 53′ through the connection wires 55, 55′, a heat dissipating space is formed between the first connection bar 51 and the second connection bar 53, 53′. As a result, even if a high voltage is supplied to the terminals 31, 31′, heat caused by the high voltage is conducted to the first connection bar 51 and the second connection bar 53, 53′ Hence, the heat is dissipated due to convective temperature.

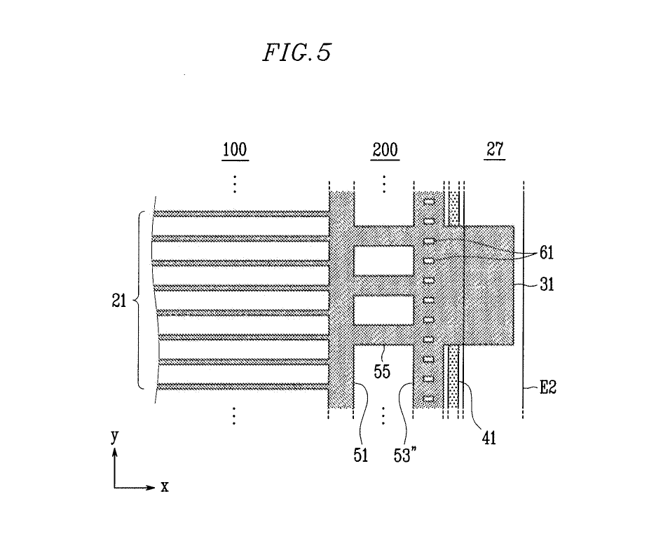

FIG. 5 shows a plurality of holes 61 formed through the second connection bar 53″. Referring to FIG. 5, the holes 61 are selectively formed only through the second connection bar 53″. However, the holes 61 may be formed through the first connection bar 51.

When a driving voltage is supplied to the terminals 31 to be transmitted to he sustain electrodes 21, the holes 61 formed through the second connection bar 53″ distribute a current flowing through the second connection bar 53″ instead of concentrating the current, thereby avoiding high heat generation.

According to the aforementioned exemplary embodiment, because terminals of the sustain electrodes are formed with a first connection bar and a second connection bar, even if a high voltage is supplied through the terminals, heat can be easily diffused and dissipated through the first and second connection bars.

Because the second connection bar can be located to be exposed to the air, heat can be rapidly diffused to the air, thereby facilitating heat dissipation of the terminal.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel comprising:
a first substrate;
a second substrate facing the first substrate;
barrier ribs arranged on the second substrate to form discharge cells in a discharge area between the first substrate and the second substrate;
first electrodes and second electrodes on the first substrate facing each other in the discharge cells;
a first connection bar connecting end portions of the first electrodes outside the discharge area;
a second connection bar electrically connected to the first connection bar; and
terminals extending from the second connection bar.

2. The plasma display panel of claim 1, wherein the second connection bar is spaced apart from the first connection bar.

3. The plasma display panel of claim 1, wherein edges of the first substrate and the second substrate are sealed with a sealant, and the first connection bar is located at an area sealed within a boundary of the sealant.

4. The plasma display panel of claim 3, wherein the second connection bar is adjacent to the sealant in an inner side of the area sealed within the boundary of the sealant.

5. The plasma display panel of claim 3, wherein the second connection bar is adjacent to the sealant outside the area sealed within the boundary of the sealant.

6. The plasma display panel of claim 1, wherein holes are located in the second connection bar.

7. The plasma display panel of claim 1, wherein holes are located in the first connection bar.

8. The plasma display panel of claim 1, wherein holes are located in the first connection bar and the second connection bar.

9. A plasma display panel comprising:
a first substrate;
a second substrate facing the first substrate;
barrier ribs arranged on the second substrate between the first substrate and second substrate;
address electrodes arranged on the second substrate extending in a first direction;
scan electrodes and sustain electrodes arranged on the first substrate extending in a second direction crossing the first direction;
a first connection bar connecting end portions of the sustain electrodes, the first connection bar extending in the first direction;
a second connection bar electrically connected to the first connection bar, the second connection bar extending in the first direction; and
terminals extending from the second connection bar.

10. The plasma display panel as claimed in claim 9, the plasma display panel further comprising:
a sealant located at edges of the first substrate and the second substrate, wherein the second connection bar is located within an area sealed within a boundary of the sealant.

11. The plasma display panel as claimed in claim 9, the plasma display panel further comprising:
a sealant located at edges of the first substrate and the second substrate, wherein the second connection bar is located outside an area sealed within a boundary of the sealant.

12. The plasma display panel as claimed in claim 9, wherein holes are located in the first connection bar.

13. The plasma display panel as claimed in claim 9, wherein holes are located in the second connection bar.

14. The plasma display panel as claimed in claim 9, wherein holes are located in the first connection bar and the second connection bar.

15. A sustain electrode terminal for connecting sustain electrodes in a plasma display panel, the plasma display panel having a first substrate and a second substrate and a sealant located at edges of the first substrate and the second substrate, the sustain electrode terminal comprising:
a first connection bar connecting end portions of the sustain electrodes, the first connection bar extending perpendicular to the sustain electrodes;
a second connection bar electrically connected to the first connection bar and spaced apart from the first connection bar, the second connection bar extending perpendicular to the sustain electrodes; and
terminals extending from the second connection bar.

16. The sustain electrode terminal as claimed in claim 15, wherein the second connection bar is located within an area sealed within a boundary of the sealant.

17. The sustain electrode terminal as claimed in claim 15, wherein the second connection bar is located outside an area sealed within a boundary of the sealant.

18. The sustain electrode terminal as claimed in claim 15, wherein holes are located in the first connection bar.

19. The sustain electrode terminal as claimed in claim 15, wherein holes are located in the second connection bar.

20. The sustain electrode terminal as claimed in claim 15, wherein holes are located in the first connection bar and the second connection bar.
